(19) United States
(12) Patent Application Publication
(10) Pub. No.: US 2016/0153829 A1
(43) Pub. Date: Jun. 2, 2016

(54) VIBRATION SENSOR

(71) Applicant: Per-Axel UHLIN, Ängelholm (SE)

(72) Inventor: Per-Axel UHLIN, Angelholm (SE)

(21) Appl. No.: 14/900,410

(22) PCT Filed: Jun. 19, 2014
(86) PCT No.: PCT/SE2014/000086

§ 371 Date: Dec. 21, 2015

(30) Foreign Application Priority Data
Jun. 20, 2013 (SE) 1300442-9

(51) Int. Cl. G01H 11/02

(52) U.S. Cl. CPC G01H 11/02

(57) ABSTRACT

The invention relates to a vibration sensor 1 for registration of vibrations in the vertical and horizontal point of the vibration sensor, where a movable part 9, comprising at least one magnet 7, is movably arranged in a holder 2, where the holder 2 comprises a in the upper part of the holder 2 arranged magnet 5T and a in the bottom part of the holder 2 arranged magnet 5B, where the movable part 9 is freely movable between the in the upper part of the holder 2 arranged magnet 5T and the in the bottom part of the holder 2 arranged magnet 5B, further the movable part 9 is enclosed/environed by at least one coil 6 in which the movable part 9, completely or partially, is freely movable.

Definition of Vibration:

Based on mechanic,
that elastic material and/or part of elastic material connected together by elastic or solid “bridges” in a-periodic movements acting from lower to highest frequencies and mostly lower amplitudes
that non elastic material can be by mechanical power in the status of suspense/tautness with the result
that this material has the possibility for vibrations of any kinds of frequency and amplitude e.g. earth quake
vibration is directly to feel and/ or to hear and/ or to see, in opposite e.g. to oscillation and/or pulsation mostly indirect to sense and/or record.
e.g. vibrations are into music not desired, oscillation with clear frequencies and amplitude are desired
that means, vibrations have mostly not defined spectrum/range of frequencies/amplitudes, in the reality it is a mixture of different frequencies and amplitudes
so vibrations can be and are dangerous for material, live stock, human e.g. by noise or mechanical waves and can destroy materials (ultra sonic tools) and sensors e.g. ears

Following by this above short description is to find into the literature about vibration sensors different types of sensors are acting by optic, acoustic, common electric, piezoelectric and other signals which are created by nature and/or artificially by human.

Human vibration sensors are e.g. eyes, ears, fingertips and skin named “haptik” as human fine perceptual.

In this paper only the group of inductive sensors are involved e.g. operate by induction or acting like a differential transformer and/or perform inductive displacement transducer or distance sensor.

Patents about these vibration sensors are e.g. described in class 73, 517R and class 73, 654 R.

Patents describing the different vibration sensors are e.g. WO 2013029286 (A1) Entitled “Inertial measurement unit of unmanned aircraft”, patent document US 2013025346 (A1) entitled “Long-period vibration sensor and method for correcting output value of the long-period vibration sensor”, patent document WO2013007071 (A1) entitled “Sensor for probing geological disaster and monitoring and alarming device thereof”, patent document EP 2546185 (A1) entitled “Vibration absorber”, patent document HY131771 (A1) entitled “Multi-input, multi-output motion control for lithography system”, patent document EP2543619 (A1) entitled “Vibration damper system”, patent document US2013002244 (A1) entitled “Mems-based magnetic sensor with a lorentz force actuator used as force feedback”, US 2012319866(A1) entitled “Wireless sensor device and method for wirelessly communicating a sensed physical parameter”, Patent document US2012313784 (A1) entitled “Portable reverse alarm system”, patent document US2012287757 entitled “Forward looking seismics from drill-bit”, patent document RU2465557 (C1) entitled “Electromagnetic device, as well as vibration type sensor with said electromagnetic device”, patent document WO2012156507 (A2) entitled “System for making available information which represents a vibration state for the operation of vibration-emitting machines, in particular construction machines”. Prior art are further described in U.S. Pat. No. 2,852,243, U.S. Pat. No. 3,100,292, U.S. Pat. No. 3,129,347, U.S. Pat. No. 3,308,647 and U.S. Pat. No. 3,483,759.

All of this above patents are based mostly of the Lenz law, based originally on Faraday's law of induction and also Lorentz force.

In the above patents inductive effects are created by extraneous/outside vibrations affecting the movable permanent centre magnet and recorded by surrounded coils or inverse movable centre coil and surrounded permanent magnet.

Mostly—as will be find in this literature—one permanent magnet affects a surrounding coil.

Into this coil the “extraneous” movement of the permanent magnet create induction, which can be registered and recorded.

Inverted, the same applies for moving coil.

All kind of vibration sensors, that are available at the market, are made according this construction and design. By measurements and field trials the result are only low signals and also not specific spectrums—as a fingerprint for persons, vehicles or any traffic, or to create different fingerprints to detect intrusion into different objects.

Usually one permanent centre magnet is fixed on the top and/or bottom in this direction that the polarity is south to south movable magnet to fixed magnet and/or also the other side north to north.

By this arrangement the movable magnet is hold by repelling effect free to move but softly dumped.

This repelling effect create, that any kind of vibrations can be recorded only soft muted and also the “extraneous” movements of the centre magnet can create only “muffled” induction into the coil(s).

For better sensibility was found out by this invention that this above repelling/damped effect not created the expected sensibility.

So an other way was invented in this kind, that the fixed magnet on the top was not in repelling direction—as described before—but in attraction direction in this wise, that the moveable part is to the bottom hold by the fixed magnet in repelling direction and the fixed magnet on the top in attraction direction.

It was found out , that the distance between the top fixed attraction magnet to the moveable part (magnets) must be so adjusted, that the moveable part (magnets) is not lifting to the top.

By this adjustment the sensibility is optimized.

The “normal” effects detected by a lot of measurements and field tests with commercial sensors—as described in the patents listed above and found into the actual market—have indicated the idea for the following invention of a better and much more thin-skinned, telling and recording vibration sensor collecting more and better signals from the surroundings.

The invention therefore relates to an improved vibration sensor as follows:
moveable part 9 with a number of more than two repelling permanent magnets 7, the top and the bottom has permanent magnets 5B and 5T so that the moveable part 9 is by this in equilibrium/balance
this part 9 is inside the outer tube 4 with special design of the tube 4 with one or more slot(s) in open design
the outer tube 4 is surrounded by a number of high winding coils 6
this number of coils 6 are one more than magnets 7
the fixed distance of the air gap 10 and the fixed length of the magnets 7 create the power of the induction fields into the coils 6
for the recording of the induction fields the design of the spacers 8 between the coils 6 is of relevance.
the number of windings of the coils 6 depends of the area of the induction fields created by the magnets 7 in movable part 9
by these above claims the sensor is working both vertically and horizontally in high sensibility
by this special design of the slots(s) 15 the movement of part 9 is greater and thus the signal more effective.
that this sensor is connected wirelessly by the units 11 and 12 with other sensors—same types or other types—and can by this—e.g. with triangulation calculate the position (vertical and/ or horizontal) and/or ways/times, differences/delays—given the exact locations of any signals in and out the area. The ring-form 16 includes all units and can also be used separately.
the units 11, 12 and 13 are arranged on the top of the holder/capsule 2
The units 11, 12 and 13 can also be arranged in the ring-form 16 around the attachment/connector 3
the induction signals by coils 6 will be accepted by the coil 6/Tr1 around the attachment 3
the attachment 3 and this coil 6/Tr1 is surrounded by the transmitting coil 6/Tr2 located in the ring-form 16 in such a way that the signals by coils 6 will come as inductive signals wireless to the unit 11 and 12
this inductive wireless signals by coil 6/Tr1 to coil 6/Tr2 need not any auxiliary energy. The coils are integrated in each other and have for this application a special design
this arrangement of unit 11 and 12 can also be used for other signals coming via coil 6/Tr1 over coil 6/Tr2 e.g. noise, light or ultrasonic by relevant sensors
this arrangement of 11, 12 and 13 on the top of holder 2 can also be used for other signals like noise or light or ultrasonic by relevant sensors

The invention relates to an improved vibration sensor for registration of vibrations vertically and horizontally where a movable part, comprising at least one magnet, is movably arranged in a holder, where the holder comprises a in the upper part of the holder arranged magnet and a in the bottom part of the holder arranged magnet where the movable part is freely movable between the in the upper part of the holder arranged magnet and the in the bottom part of the holder arranged magnet, further the movable part is enclosed/environed by at least one coil in which the movable part, completely or partially, is freely movable.

The improved vibration sensor is further characterized by;

the magnets in the movable part being arranged to repel the in the bottom part of the holder arranged magnet and where the magnets in the moveable part are arranged to attract the in the upper part arranged magnet.

the moveable part being arranged so that the movable part is in equilibrium/balance between the upper part of the holder arranged magnet and the in the bottom part of the holder arranged magnet.

the movable part being arranged in a tube with a around the movable part surrounding air gap between the movable part and the tube.

the tube is arranged with at least one slot.

the number of coils are more than the number of magnets, where the magnets are arranged in the movable part and where the coils are separated by spacer rings between the coils.

an evaluation unit, a transmitter and receiver and a battery being arranged in the vibration sensor, where the transmitter and receiver are arranged for communication with other vibration sensors and where the battery provides the evaluation unit and the transmitter and receiver with electric energy.

the vibration sensor being arranged with a transformer coupling of a first coil and a second coil where the coils are electric arranged to the first coil and where the first coil is inductively connected to the second coil and where the second coil inductively transmits signals to the evaluation unit and transmitter and receiver.

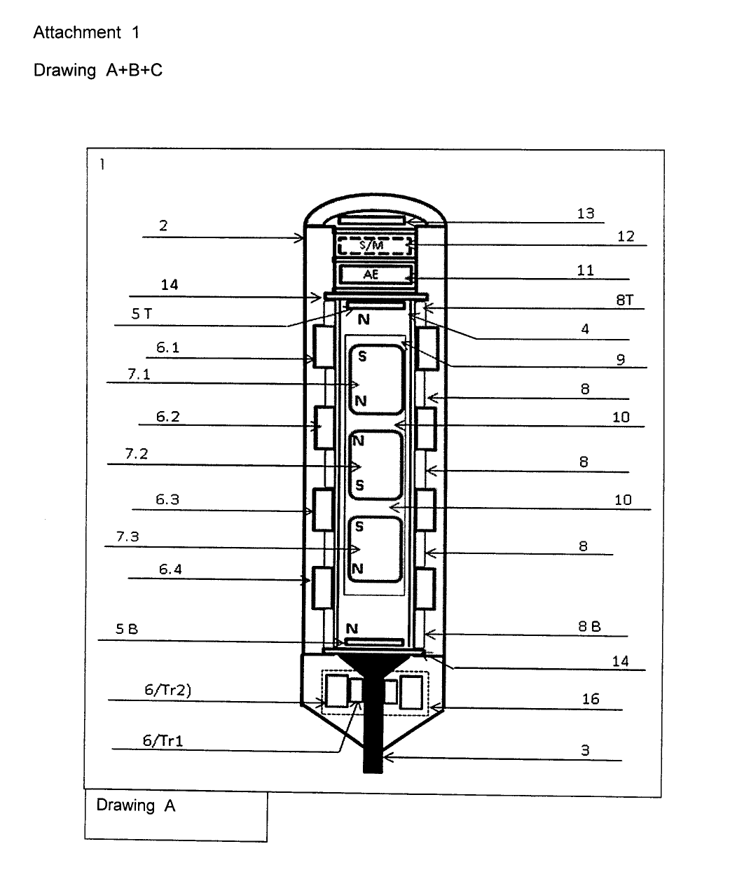

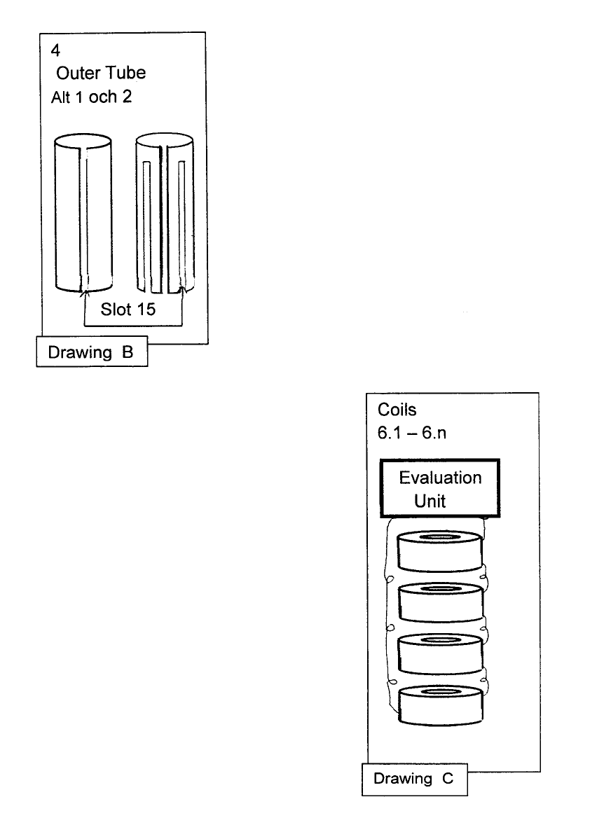

The invention is described as follow. See drawings A+B+C in FIG. 1.

### SHORT DESCRIPTION OF THE FIGURES

1 Sensor Unit
2 Holder/Capsule
3 Attachment/Connector
4 Outer Tube
5T Fixed Magnet
5B Fixed Magnet
6.1 Coil
6.2 Coil
6.3 Coil
6.4 Coil
6/Tr1 Coil
6/Tr2 Coil
7.1 Magnet
7.2 Magnet
7.3 Magnet
8 Space Ring
8T Space Ring
8B Space Ring
9 Inner Movable Part
10 Air Gap
11 Evaluation Unit
12 Transmitter/Receiver
13 Battery
14 Support Washer
15 Slot in p. 4 above. See Drawing B
16 The Ring

Agenda
1 the whole vibration sensor unit.
2 outer holder/capsule, fabricated by plastic and waterproofed and without electric connection to outer tube 4 or other items and insulated to the spacers rings 8 and also to the attachment/connector 3 by the support washer 14.
2/1 in the capsule 2 coils 6.1 to 6.n are placed, by the spacers 8, hold in distance between and by the spacers 8T and 8B to the fixed magnets 5B and 5T.
2/2 on the top of the capsule 2 the evaluation unit 11 and the transmit/receive/storage unit 12 and battery unit 13 is installed included connection to the outside for charging by every kind.
2/3 all coils 6 have minimum of 5.000 windings, mostly 2-6 times more
4/1 an outer tube 4 with outer diameter like the inner diameter of the coils 6.
4/2 an inner diameter of the outer tube 4 so that the movable permanent magnets 7.1 to 7.n inside the movable part 9. can move freely inside the outer tube 4.
4/3 outer tube 4 fabricated by an electric conductivity material—mostly metal—e.g. copper or alumina
4/4 this above mentioned outer tube 4 has axial one or more grove(s) see drawing B
2/5 the fixed magnet 5B and the fixed magnet 5T are permanent magnets and fixed by spacers 8B and 8T. The magnets 5B and 5T have no connection to outer tube 4 and hold part 9 in balance/equilibrium by repelling polarity 5B and attraction polarity 5T
9/1 inner movable part 9 with two and or more permanent magnets 7 has an outer diameter that is a little bit smaller than the inner diameter of outer tube 4, so that part 9 is in free mobility and equilibrium into part 4 as described before
9/2 this movable part 9 includes magnets 7 which are in repelling polarity too each other
9/3 in this movable part 9 the magnets 7 are fixed in e.g. plastic or metal, and have a defined distance between each other e.g. max 10 mm or mostly a smaller distance, named air gap 10
7/1 these permanent magnets 7 are one number less than the number of the coils 6. The length of the magnets 7 are mostly the same. The maximum lengths are e.g. maximum 30 mm and minimum 10 mm
7/2 these permanent magnets 7 have in the centre an axial hole, through the whole part 9 and all magnets 7, so that by any movement, there will never be any compressed atmosphere, oil or other medium in the chambers top or bottom that can dampen the movement created by affecting vibrations
8 the number of spacer rings are (besides the two, 8T and 8B fixed), one minus the numbers of coils 6.
The height of the spacer rings 8 between the coils is the same.
The height of the spacer rings 8T and 8B is smaller or bigger than the spacer rings 8.
9/4 the groove(s) in the outer tube 4 can be one or more groove(s).
See: Attachment 1, drawing B Alt 1 and Alt 2.
The outer tube 4 is to be regarded as coil with one winding.
See: Attachment 1, drawing B Alt 1 and 2.

The goal for the work was therefore to find e.g. a better way and design to become e.g. signals from longer distances, spectrums for specific objects and also the possibility to build in GPS—systems as a part of the evaluation unit 11, and/or to locate the suspicious and/or unknown vibrations.

The first area to promote better signals was to see in which way—by the background how an induction signal was generated—the sensor can be made by any other, better or more sophisticated design.

In a lot of field trials it was found—and that was not preliminary expected—that more permanent magnets 7 and also relevant numbers of high numbered winding coils 6 bring more powerful induction signals and in combination, that the permanent magnets 7 where coupled to pairs in such form, like in part 9, that the resulting magnetic fields was compressed between the same polarities in a defined air gaps 10 to create higher induction in the relevant coils 6.

It was also found in these trials—what was not in knowledge before—, that the distance, of air gap 10, and the polarities of the permanent magnets 7 in part 9 were both important for the quality and quantity of the signals.

After more trials was a additional effect found—it was also not expected too—that the outer tube 4 through his special design produced a greater induction in part 6 due to the better mobility and larger amplitude of part 9, due to smaller damping of the metal tube 4.

The combination repelling magnet 5B and very exactly adjusted attraction magnet 5T has given the best sensibility and the best damping by external influences so that different vibrations are better indicated, determinated and indentified regarding what/who caused the interference/vibration.

Also, the combination of coils spaced apart by spacers 8, and located opposite the air gaps 10, has more than double the induction by more coils 6 and permanent magnets 7.

The connecting in series of the coils 6 together with the powerful magnetic influence coming from the air gap 10 areas, ensured that the sensibility became much better than the constructions and designs available on the market or described in the literature.

It was also found without expectation, that not only vertical vibrations where indicated, to surprise also horizontal vibrations where indicated many times better then from every other vibration induction sensors from the market.

Based on these unexpected but real results the following claims are for the vibration sensor:

1. Vibration sensor (1) for registration of vibrations in the vertical and horizontal point of the vibration sensor (1), the sensor comprising:
a movable part (9), comprising at least two magnets (7), are movably arranged in a holder (2), where the holder (2) comprises a in the upper part of the holder (2) arranged magnet (5T) and a in the bottom part of the holder (2) arranged magnet (5B) where the movable part (9) is freely movable between the in the upper part of the holder (2) arranged magnet (5T) and the in the bottom part of the holder (2) arranged magnet (5B), further the movable part (9) is enclosed/environed by at least one coil (6) in which the movable part (9), completely or partially, is freely movable, where the number of coils (6) are more than the number of magnets (7) which are arranged in the movable part (9).

2. Vibration sensor (1) according to claim 1, wherein the magnets (7) in the movable part (9) are arranged to repel the in the bottom part of the holder (2) arranged magnet (5B) and where the magnets (7) in the movable part (9) are arranged to attract the in the upper part of the holder (2) arranged magnet (5T).

3. Vibration sensor (1) according to claim 1, wherein the moveable part (9) is arranged so that the movable part (9) is in equilibrium/balance between the in the upper part of the holder (2) arranged magnet (5T) and the in the bottom part of the holder (2) arranged magnet (5B).

4. Vibration sensor (1) according to claim 1, characterized in that the movable part (9) is arranged in a tube (4) with a around the movable part (9) surrounding air gap between the movable part (9) and the tube (4).

5. Vibration sensor (1) according to claim 4, wherein the tube (4) is arranged with at least one slot (15).

6. Vibration sensor (1) according to claim 1, wherein the coils (6) are separated by spacer rings (8) between the coils (6).

7. Vibration sensor (1) according to claim 1, wherein an evaluation unit (11), a transmitter and receiver (12) and a battery (13) are arranged in the vibration sensor (1), where the transmitter and receiver(12) are arranged for communication with other vibration sensors (1) and where the battery (13) provides the evaluation unit (11) and the transmitter and receiver (12) with electric energy.

8. Vibration sensor (1) according to claim 1, wherein the vibration sensor (1) is arranged with a transformer coupling of a first coil (6/Tr1) and a second coil (6/Tr2) where the coils (6) are electric arranged to the first coil (6/Tr1) and where the first coil (6 Tr1) is inductively connected to the second coil (6/TY2) and where the second coil (6/Tr2) inductively transmits signals to the evaluation unit (11) and transmitter and receiver (12).
